(19) United States
(12) Patent Application Publication
(10) Pub. No.: US 2024/0256824 A1
(43) Pub. Date: Aug. 1, 2024

(54) NEURAL NETWORK FOR GENERATING BOTH NODE EMBEDDINGS AND EDGE EMBEDDINGS FOR GRAPHS

(71) Applicant: Salesforce, Inc., San Francisco, CA (US)

(72) Inventors: Akash Singh, Gurgaon (IN); Rajdeep Dua, Hyderabad (IN)

(21) Appl. No.: 18/138,969

(22) Filed: Apr. 25, 2023

(30) Foreign Application Priority Data
Jan. 30, 2023 (IN) 202341005968
Jan. 30, 2023 (IN) 202341005985

(51) Int. Cl. G06N 3/04

(52) U.S. Cl. CPC G06N 3/04

(57) ABSTRACT

A method for using a neural network to generate node embeddings and edge embeddings for graphs. The neural network has K layers. The graph includes multiple nodes and edges linking the multiple nodes. The method includes determining a set of node features for the multiple nodes, and determining a set of edge features for the multiple edges. A first layer of the neural network is applied to the node features and the edge features to output a first set of node embeddings and a first set of edge embeddings. A k-th layer of the neural network is applied to (k−1)th set of node embeddings and (k−1)th set of edge embeddings to output a k-th set of node embeddings and a k-th set of edge embeddings, where the (k−1)th set of node embeddings and (k−1)th set of edge embeddings are output from (k−1)th layer of neural network.

### RELATED APPLICATION

This application claims the right of priority based on India Provisional Patent Application Serial No. 202341005985, entitled “Classifying Nodes or Edges of Graphs Based on Node Embeddings and Edge Embeddings”, filed Jan. 30, 2023, and India Provisional Patent Application Serial No. 202341005968, entitled “Neural Network for Generating Both Node Embeddings and Edge Embeddings for Graphs”, filed Jan. 30, 2023, the content of each of the foregoing are incorporated herein by reference in its entirety.

### BACKGROUND

### Field of Art

This disclosure generally relates to neural networks, more specifically relates to a neural network that is trained to generate node embeddings and edge embeddings representing nodes and edges of a graph.

### Description of the Related Art

Neural networks, also known as artificial neural networks (ANNs), are a subset of machine learning. Their name and structure are inspired by the human brain, mimicking the way that biological neurons signal to one another. ANNs often have multiple layers, including an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network. Neural networks rely on training data to learn and improved their accuracy over time. Once the neural network is trained, it is a powerful tool in artificial intelligence, allowing people to classify and cluster data at a high velocity and accuracy.

Many real world datasets can be represented as graphs. Representing data as graphs provides a method of expressing the different ways participating entities can be connected to and interact with each other. Some neural networks are developed to operate on graph data. Such neural networks are called graph neural networks (GNNs).

### BRIEF DESCRIPTION OF DRAWINGS

FIG. 1 is an example graph generated based on a lead management system, in accordance with one or more embodiments.

FIG. 2 is a block diagram illustrating an example neural network system, in accordance with one or more embodiments.

FIG. 3A illustrates an example neural network having K layers, in accordance with one or more embodiments.

FIG. 3B illustrates an example kth layer of the neural network in FIG. 3A, in accordance with one or more embodiments.

FIG. 3C illustrates an example network that may follow the neural network of FIG. 3A configured to perform node classification, in accordance with one or more embodiments.

FIG. 3D illustrates an example network that may follow the neural network of FIG. 3A configured to perform edge classification, in accordance with one or more embodiments.

FIG. 4 is a flowchart of an example method for determining node embeddings and edge embeddings for nodes or edges in graphs, in accordance with one or more embodiments.

FIG. 5 is a flowchart of an example method for determining a set of node embeddings for a target node in kth layer of a neural network, which corresponds to step 460 of FIG. 4, in accordance with one or more embodiments.

FIG. 6 is a flowchart of an example method for determining a set of edge embeddings for a target edge (u, v) in kth layer of a neural network, which corresponds to step 470 of FIG. 4, in accordance with one or more embodiments.

FIG. 7 is a block diagram illustrating the architecture of a typical computer system for use in the system of FIG. 2, in accordance with one or more embodiments.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements.

### DETAILED DESCRIPTION

Existing graph neural networks (GNNs) have some limitations. First, most of the GNNs are limited to using node features to calculate node embeddings, which are then used in downstream machine-learning (ML) models. However, in many scenarios, important information is present as edge features, which are not utilized by existing graph neural networks. Further, most GNNs only work with single type of nodes and edges. In complex business processes and domains, there are different types of entities interacting with each other in many different ways, which cannot be captured by existing GNNs.

For example, in many data systems, a lead is a prospective customer represented by an individual and/or a company. Some lead management systems allow customers to score their leads and prioritize the leads based on their scores. Such a lead scoring system may use a machine learning (ML) model to generate lead scores. The output score indicates the likelihood of lead conversion based on historical data on leads and conversions. Such an ML model is often based on tabular data, including fields as features, such as industry, state, annual revenue, lead source, lead status, department, job rank, etc. Even though these features are relevant to a likelihood of lead conversion, such an ML model, operating on tabular data, is limited in the way that each row of data is independent of all others, because the real world relationships include complex connections and interactions between companies, customer, and salespersons. These connections and interactions have a bearing on lead conversion but cannot be captured by an ML model operating on tabular data.

Embodiments described herein solve the above-described problems by implementing a novel neural network system (hereinafter also referred to as “the system”). To capture the real-world connections and interactions between different entities, the system described herein models data as a heterogeneous knowledge graph. Nodes in the graph represent entities. The edges in the graph represent interactions and relationships between the nodes. For each node, a set of node features is determined based on information associated with the node. For each edge, a set of edge features are determined based on information associated with the edge. The neural network includes multiple (denoted as K) layers. A first layer is applied to the node features and edge features to generate a first set of node embeddings and a first set of edge embeddings.

A kth layer is applied to a (k−1)th set of node embeddings and (k−1)th set of edge embeddings to generate a kth set of node embeddings and a kth set of edge embeddings. For example, when k=2, a second layer of the neural network is applied to the first set of node embeddings and the first set of edge embeddings to generate a 2^{nd} set of node embeddings, and a 2^{nd} set of edge embeddings. When k=3, a 3^{rd} layer of the neural network is applied to the 2^{nd} set of node embeddings and the 2^{nd} set of edge embeddings to generate a 3^{rd} set of node embeddings, and a 3^{rd} set of edge embeddings. This process repeats as many times as necessary, until the Kth set of node embeddings and the Kth set of edge embeddings are determined, which are also referred to as final set of embeddings.

The final set of embeddings can then be input into a classifier head, a linear layer, and a softmax layer. The classifier head receives the final set of node embeddings or the final set of edge embeddings, and passes the final set of node embeddings through the linear layer and the softmax layer to output a classification score, which can then be used to determine whether the corresponding node or edge is classified as positive or negative for the classification.

For example, the entities may include (but are not limited to) a sales company, a salesperson, an account/customer company, a lead/contact person, etc. The edges linking the nodes represent interactions and relationships between the nodes. The edges include an edge that links a lead and a salesperson. The final set of edge embeddings of the edge may be used to predict a likelihood of whether the lead is to be converted to a customer by the salesperson.

### Example Graph

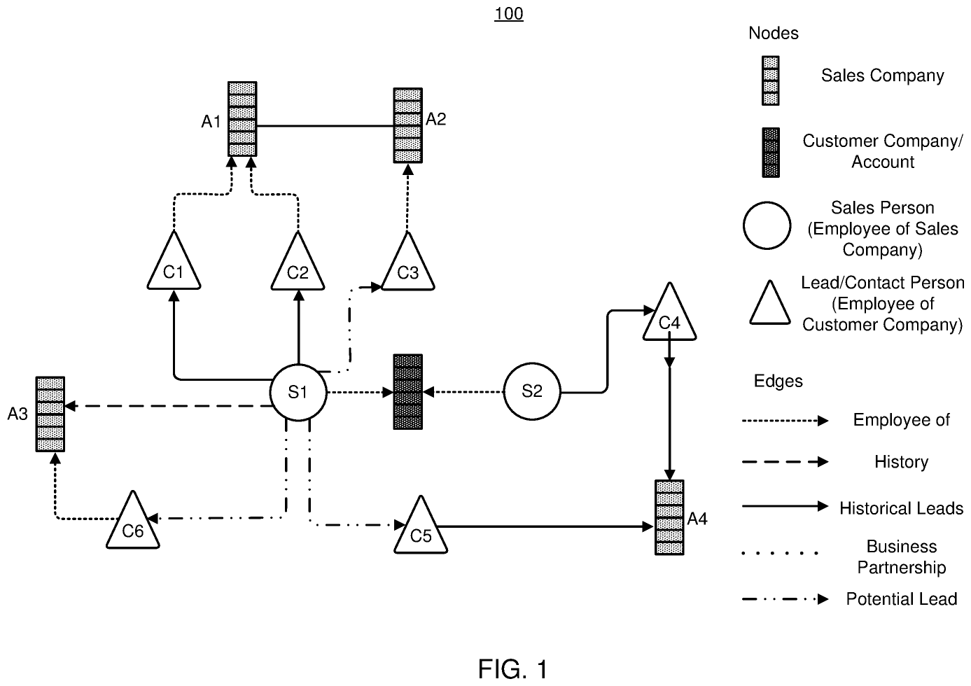

FIG. 1 is an example graph 100 generated based on a lead management system. The graph 100 includes a plurality of nodes and a plurality of edges linking the plurality of nodes. As illustrated, the plurality of nodes corresponds to a plurality of different types of entities, including sales companies, customer companies/accounts, sales persons, and leads/contact persons. A sales company is a company that uses lead scoring to rank potential leads. A salesperson is a salesperson employed by the sales company. An account/customer company is a customer or potential customer of the sales company. A lead/contact person is an employee of an account company, who is a lead for a salesperson and contacted by the salesperson. The lead/contact person is a decision maker who has the authority to decide whether to make a deal with a sales company that the salesperson represents.

The edges in the graph 100 represent interactions and relationships between the nodes. The interactions and relationships may include (but are not limited to) an employee-employer relationship, a history between two entities, a business partnership, a historical lead, a potential lead, a department, a job, etc. For example, an edge representing an employee-employer relationship linking a salesperson and a sales company indicates that the salesperson is an employee of the sales company; an edge representing a history of two entities linking the salesperson and a second sales company indicates that the salesperson is a former employee of the second sales company; an edge representing a business partnership of two entities linking two companies indicates that the two companies have a business association; an edge representing a historical lead linking an account company and a sales company with a conversion label 1 or 0 indicates the account company has been converted or not converted; an edge representing a potential lead linking an account company and a sales company indicates the account company is to be scored by the model for predicting a conversion score.

Business networking and relationships are crucial in sales. For example, the edge linking S1 and C3 indicates that salesperson S1 does not have any history with lead/contact C3 or Account A2, while edge linking A1 and A2 indicates that company A2 has a business alliance with A1, which increases the chance of converting the lead C3 by S1. The edge linking S1 and C4 indicates that S1 has a history with Account A3, which also increases the chance of converting the lead C3 by S1. Further, there is no edge between C5 and A4, but S2 (who is S1's colleague) has converted lead C4, who works at A4. Thus, S1 can utilize S2's knowledge and contacts to convert C5.

However, these relationships cannot be captured in a tabular dataset, nor can they be captured by existing neural network models or GNN models. Embodiments described herein use a novel neural network system to capture these connections. The system is configured to model nodes and their complex relationships in a heterogenous graph. The system is able to process node/entity features, so that the system can make use of entity features or fields. The system is also able to process edge/relationship features, which provide information on the nature and characteristics of the connection between nodes.

The system described herein provides many advantages compared to existing neural networks or GNNs. First, it is advantageous for the system to consider both node features and edge features in scoring. This allows the system to exploit edge connections while making predictions, i.e., making use of graph structure and local topology. For example, the system is able to train an edge classifier to output lead scores for a given edge. It is also advantageous for the system to be able to handle disparate nodes and edges that represent different entity types and relationships, which is often the case in real-life scenarios. Additionally, the system is also able to handle evolving graphs. In particular, the system is able to score new nodes and edges without having to retrain the model. The system is also able to handle new sub-graphs, such that, the system is generalizable to new graphs/subgraphs with similar properties. This is critical as lead data is evolving with new contacts and customers being added continuously.

### Overall System Environment

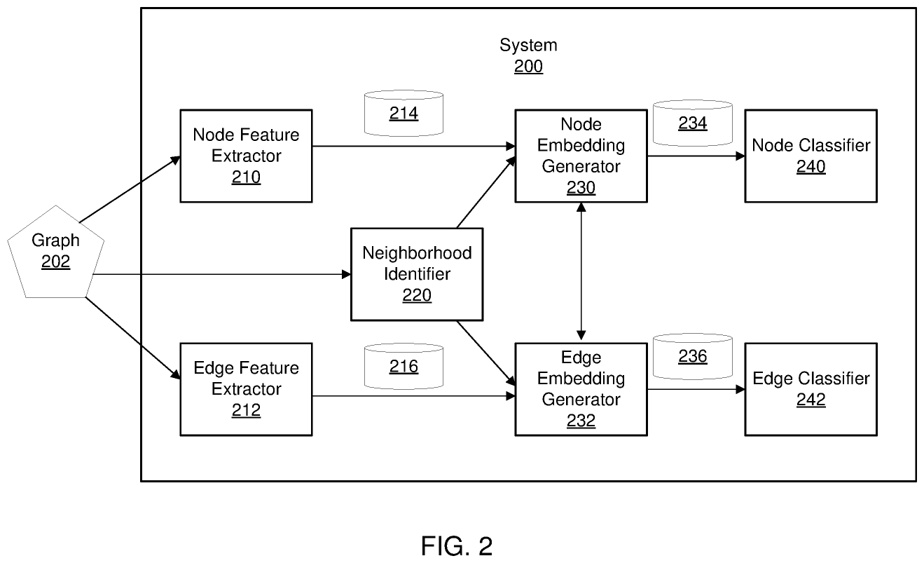

FIG. 2 is a block diagram illustrating an example system 200, in accordance with one or more embodiments. The system 200 includes a node feature extractor 210, an edge feature extractor 212, a neighborhood identifier 220, a node embedding generator 230, an edge embedding generator 232, a node classifier 240, and/or an edge classifier 242. In some embodiments, there may be more or fewer components in system 200. Alternatively, or in addition, functions of different components may be combined or redistributed. The system 200 is configured to receive a graph 202, and use data contained in graph 202 to train the node embedding generator 230, the edge embedding generator 232, the node classifier 240, and/or the edge classifier 242.

Graph 202 is denoted as [symbol] =(V, ε), where V is a set of all vertices or nodes and ε is a set of all edges. An edge is denoted as (u, v), where u∈V, and v∈V. The node feature extractor 210 is configured to extract a set of node features 214 for each node in V based on information associated with the node. The edge feature extractor 212 is configured to extract a set of edge features 216 for each edge in E based on information associated with the edge.

The neighborhood identifier 220 is configured to identify a subset of nodes that are in a neighborhood of any given node. For example, for a target node, the neighborhood identifier 220 identifies a subset of nodes that are in a neighborhood of the target node. The neighborhood may be defined to be within a number of edges from the target node. For example, if the number of edges is 2, only the nodes within two edges from the target node are in the neighborhood. In some embodiments, the subset of nodes is sampled from nodes in the neighborhood. The node embedding generator 230 is configured to obtain node features 214 of the subset of nodes, and determine a node embedding 234 for the target node based in part on the node features 214 of the subset of nodes that are in the neighborhood of the target node.

For a target edge (u, v), the neighborhood identifier 220 identifies a subset of nodes that are in a neighborhood of node u, and a subset of nodes that are in a neighborhood of node v. The node embedding generator 230 is configured to determine a set of node embedding for node v, and a set of node embedding for node u. The edge embedding generator 232 is configured to obtain edge features 216 of target edge (u, v), and determine an edge embedding 234 for the target edge (u, v) based in part on the edge features 216 of the target edge (u, v), and the set of node embeddings for node u, and the set of node embeddings for node v.

The node embeddings 234 are input to the node classifier 240. The node classifier 240 is trained to receive a set of node embeddings for any given node to output a classification, which may be a score or a binary output. For example, the node classifier 242 may be a fraud detection model. For a given node representing a merchant, the node classifier 242 is trained to predict a likelihood of whether the merchant is fraudulent before a transaction is made. The nodes in graph G are customers and merchants. The customers purchase products and services from merchants. Node features may include merchant features, such as industry, geo information, number of transactions in a recent time period (e.g., 30 days), a total amount of transactions, a number of customers transacted with a merchant, etc. The edges may represent transactions performed between merchants and customers in a recent short window (e.g., 1 day or 1 week). Edge features may include time of transaction, an amount of transaction, a type of transaction, a fraud score of transaction, etc. The node classifier 240 is trained to predict whether a merchant is fraudulent.

The edge embeddings 236 are input to the node classifier 242. The edge classifier 242 is trained to receive a set of edge embeddings for any given node to output a classification, which may be a score or a binary output. For example, the edge classifier 242 may be a merchant recommendation model. For any given edge representing a customer-merchant pair, the edge classifier 242 is trained to predict a likelihood of whether the customer is to complete a transaction with the merchant. The nodes in graph G are customers and merchants. The customers purchase products and services from merchants. The edges denote transactions between merchants and customers. Node features may include customer features, such as age, location, number of transactions, etc., and merchant features, such as type, industry, category, etc. Edge features may include transaction features such as an amount of a transaction, a type of transaction (e.g., domestic, cross border), etc. The edge classifier 242 is trained to predict whether a customer will complete a transaction with a merchant.

In embodiments, the node embedding generator 230, the edge embedding generator 232, the node classifier 240, and/or edge classifier 242 are implemented in a neural network.

### Example Neural Network

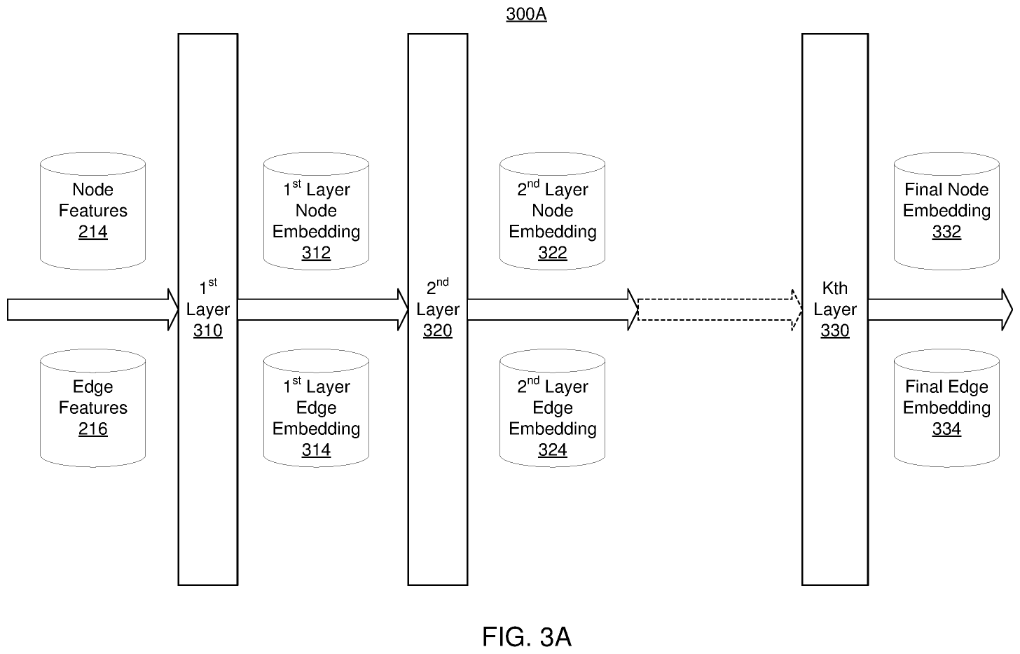

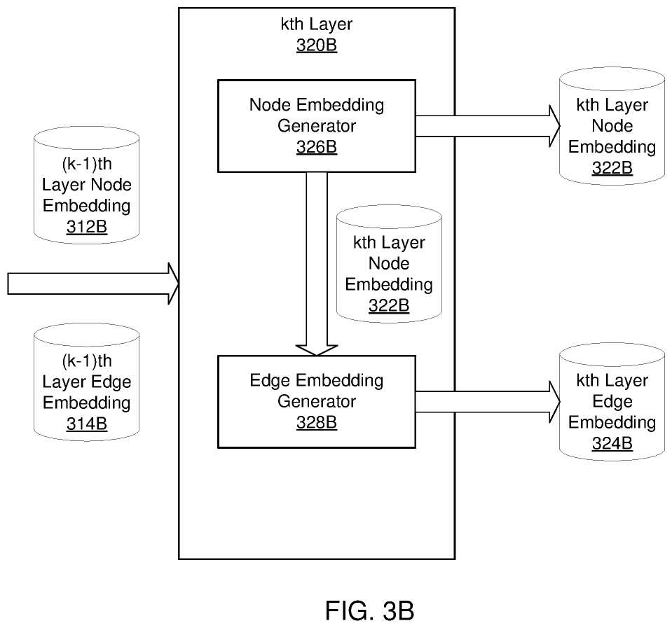

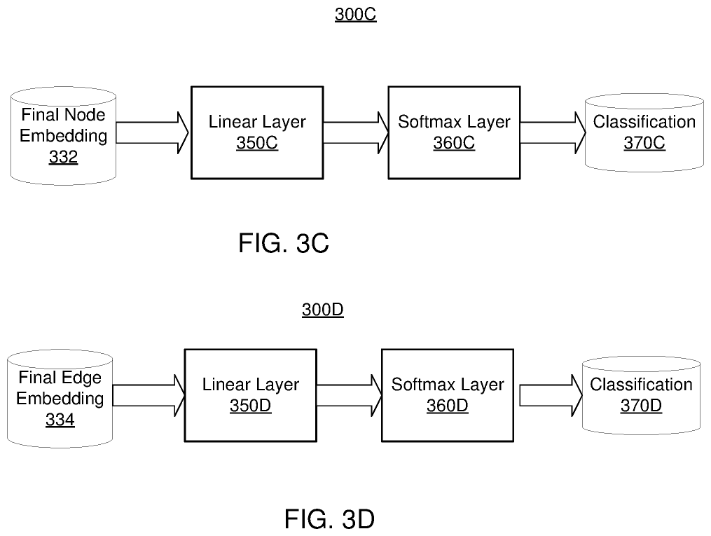

FIGS. 3A-3D illustrate example embodiments of a neural network that is trained to generate node embeddings and edge embeddings, and/or perform classifications based on the node embeddings or edge embeddings.

FIG. 3A illustrates an example neural network 300A having K layers. Search depth or number of layers in the network 300A is denoted by K>1. The individual layers are numbered from 1 to K. Weight matrices are denoted as W_{node}^{k}∀K∈{1, . . . , K}, which are per layer/depth weights that are used to transfer information from node embeddings at one layer of network 300A to the node embeddings at a next layer. A neighborhood function is denoted as N(v), which samples neighboring nodes of node v. A number of neighborhood nodes that are to be sampled is decided by constants S₁, . . . , S_{K}, ∀K∈{1, . . . , K}. K node aggregator functions are denoted as AggNodeₖ∀k∈{1, . . . , K}, which are used to aggregate nodes. K edge aggregator functions are denoted as AggEdgeₖ∀k∈{1, . . . , K}, which are used to aggregate edges. k refers to a current layer/depth of the network, and v denotes a current node being processed. Node features are denoted as {xᵥ, ∀ᵥ∈V}. Edge features are denoted as {xᵤᵥ, ∀(u, v)∈ε}.

The neural network 300A takes node features 214, and edge features 216 as input, and transforms them into node embeddings and edge embeddings. This process is iterative with one iteration for each layer in K layers of the network 300A. At each iteration, node/edge embeddings, are updated by aggregating the nodes/edges in a local neighborhood. As the process iterates, the embeddings gain more information from the graph structure.

In some embodiments, different node types may have different numbers of features, and all node features may be set to be of a same fixed length, e.g., by zero padding. During training, masking may be used to remove some of zero padded positions from gradient updates. In addition, an indicator variable (also referred to as “a first indicator variable”) may be used to define a node/entity type. This indicator variable allows the model to process different node types and preserve node type information in the node embeddings.

Similarly, in some embodiments, different edge types may have different numbers of features, and all edge features may be set to be a same fixed length, e.g., by zero padding. Masking may also be used to remove some of the zero-padded positions from gradient updates. In addition, an indicator variable (also referred to as “a second indicator variable”) may be used to define an edge/relationship type. This indicator variable allows the model to process different edge types and preserve edge type information in the edge embeddings.

First, the node embeddings, hᵥ⁰, are initialized from the node features. This process is denoted in Equation (1) below.

$${h}_{v}^{0} ← {x}_{v} , ∀ v ∈ V \qquad ( 1 )$$

Further, the edge embeddings are initialized using the edge features. This process is denoted in Equation (2) below:

$${e}_{uv}^{0} ← {r}_{uv} , ∀ ( u , v ) ∈ ε \qquad ( 2 )$$

For k=1, . . . K, for v∈V, a set of processes are performed. The set of processes is denoted by Equations (3)-(5) below. The multiple steps include a process of computing an aggregate vector representation h_{N(v)}^{k} of the neighborhood nodes of v at depth k. In embodiments, this is performed by applying AggNodeₖ function to the vector representation of the neighboring node hᵤ^{k-1} at depth k−1. The neighboring nodes are provided by N(v). This process is denoted by Equation (3) below.

$${h}_{N ( v )}^{k} ← {AggNode}_{k} ( \{ {h}_{u}^{k - 1} , ∀ u ∈ N ( v ) \} ) \qquad ( 3 )$$

The set of processes further includes a process of computing an aggregate vector representation of the neighboring edges of v at depth k. In embodiments, this is performed by applying AggEdgeₖ function to the vector representation of the neighboring edges (eᵤᵥ^{k-1}) at depth k−1. This process is denoted by Equation (4) below.

$${e}_{N ( v )}^{k} ← {AggEdge}_{k} ( \{ {e}_{uv}^{k - 1} , ∀ ( u , v ) ∈ ε : u ∈ N ( v ) \} ) \qquad ( 4 )$$

The set of processes further includes a process of computing the depth k embedding hᵥ^{k} of v. In embodiments, this is performed by concatenating the node's depth k−1 representation hᵥ^{k-1} with the aggregated neighborhood node vector h_{N(v)}^{k}, and the aggregated neighborhood edge vector e_{N(v)}^{k}. The concatenated vector is passed through a fully connected neural network layer with nonlinear activation σ, and depth k weighs W_{node}^{k}. This process is denoted by equation (5) below.

$${h}_{v}^{k} ← σ ( {W}_{node}^{k} \cdot CONCAT ( {h}_{v}^{k - 1} , {h}_{N ( v )}^{k} , {e}_{N ( v )}^{k} ) ) \qquad ( 5 )$$

Further, for (u, v)∈ε, the depth k embedding of edge (u, v) is computed. In embodiments, this is performed by concatenating the edge embeddings at depth k−1, with the update depth k node embeddings of nodes u and v. The concatenated vector is passed through a fully connected neural network layer with nonlinear activation σ and depth k weights W_{edge}^{k}. This process is denoted by equation (6) below.

$${e}_{uv}^{k} ← σ ( {W}_{edge}^{k} \cdot CONCAT ( {e}_{uv}^{k - 1} , {h}_{u}^{k} , {h}_{v}^{k} ) ) \qquad ( 6 )$$

In some embodiments, the node embeddings and/or edge embeddings are normalized. Equation (7) below denotes a process of normalizing the node embeddings.

$${h}_{v}^{k} ← \frac{{h}_{v}^{k}}{{‖ {h}_{v}^{k} ‖}_{2}} , ∀ v ∈ V \qquad ( 7 )$$

Equation (8) below denotes a process of normalizing the edge embeddings.

$${e}_{uv}^{k} ← \frac{{e}_{uv}^{k}}{{‖ {e}_{uv}^{k} ‖}_{2}} , ∀ ( u , v ) ∈ ε \qquad ( 8 )$$

The above-described process repeats K times before final node and/or edge embeddings are generated. For example, when k=1, for a given node v, the first layer 310 receives node features 214 (which can also be deemed as 0^{th} layer embeddings) as input. The first layer 310 determines 1st layer node embeddings 312 for node v based on Equations (3)-(5) and/or (7). For a given edge (u, v), the first layer 310 receives node features 214 for nodes u and v, and edge features 216 for edge (u, v) (which can also be deemed as 0^{th} layer embeddings) as input. The first layer 310 determines 1st layer node embeddings 314 for nodes u and v based on Equations (3)-(5) and/or (7). The first layer 310 then determines 1 st layer edge embeddings 314 for edge (u, v) based on Equations (6) and/or (8), which uses the 1st layer node embeddings for nodes u and v, and edge features for edge (u, v).

As another example, when k=2, for a given node v, the second layer 320 receives 1st layer node embeddings 312 for node v as input. The second layer 320 determines 2^{nd} layer node embeddings 322 for node v based on Equations (3)-(5) and/or (7). For a given edge (u, v), the second layer 310 receives 1st layer node embeddings 312 for node u and v, and 1st layer edge embedding 314 for edge (u, v). The second layer 320 determines 2nd layer node embeddings 322 for nodes u and v based on Equations (3)-(5) and/or (7). The second layer 320 also determines 2^{nd} layer then determines 2^{nd} layer edge embeddings 324 for edge (u, v) based on Equation (6) and/or (8), which uses 2^{nd} layer node embeddings for nodes u and v, and 1st layer edge embedding for edge (u, v).

For a given k (where 1≤k≤K), this process is further illustrated in FIG. 3B. FIG. 3B illustrates a kth layer 320B of the neural network 300A of FIG. 3A. As illustrated, the kth layer 320B receives node embeddings 312B and edge embeddings 314B output from the previous layer, i.e., (k−1)th layer, and determines kth layer node embedding 322B and edge embeddings 324B based on the (k−1)th layer node embeddings 312B and edge embeddings 314B.

In particular, the kth layer 320B includes a node embedding generator 326B that determines kth layer node embeddings 322B and edge embeddings 324B based on the (k−1)th layer node embedding 312B and edge embeddings 314B. For example, the node embedding generator 326B may apply Equations (3)-(5) and/or (7) to generate the kth layer node embeddings 322B. The edge embedding generator 328B may apply Equations (6) and/or (8) to generate the kth layer edge embeddings 324B.

This process repeats K times, until the Kth layer 330 determines Kth layer node embedding for v, and/or Kth layer edge embedding for edge (u, v), which are also referred to as final node embeddings and final edge embeddings. Equation (9) below denotes final node embeddings.

$${z}_{v} ← {h}_{v}^{K} , ∀ v ∈ V \qquad ( 9 )$$

Equation (10) below denotes final edge embeddings.

$${q}_{uv} ← {e}_{uv}^{K} , ∀ ( u , v ) ∈ ε \qquad ( 10 )$$

Note, as shown in Equation (5), at each layer, the updated node embeddings is computed based on node embeddings from a previous layer, node neighborhood vector, and edge neighborhood vector. Similar to Equation (5), in Equation (6), the edge embedding is updated by concatenating the edge embedding from the previous layer, with the updated embeddings of two nodes in the edge. This sequence of updates mixes the node and edge features together such that final edge embeddings and/or node embeddings encode relevant information from both edges and nodes. As such, the final classification layer is able to use either edge embeddings and/or node embeddings without loss of information, allowing the model to be used for both edge classification and node classification.

As discussed above, a neighborhood is denoted by N(v), which determines a set of nodes that are in a neighborhood of v. For depth/layer k, a number of neighbors to be sampled is denoted as Sₖ. In some embodiments, probabilistic Breadth First Search (BFS) is used to identify the neighborhood, where nodes at a same search-depth are picked uniformly at random. If the number of neighbors for a node is less than Sₖ, constant all 1s vectors may be used.

Once the neighboring nodes of a node are determined, a single vector representation of the neighborhood may be computed. In embodiments, this is achieved through node and edge aggregation functions. The node and edge aggregation functions may be trained or learned during the model training. The aggregation functions are the chief reason the graph is inductive and can process new unseen nodes. Once the functions are learned, they can be applied to any new nodes added to the graph.

The node aggregation function AggNodeₖ is generated by passing each neighbor's vector through a single layer neural network. This gives a set of vectors, with each element being an intermediate representation of the corresponding neighborhood node, which can then be reduced to a single vector by a pooling operation. In embodiments, max pooling is used. This process is denoted by Equation (11) below.

$${AggNode}_{k} = maxpool ( \{ σ ( {W}_{aggn} {h}_{u}^{k} + b ) , ∀ u ∈ N ( v ) \} ) \qquad ( 11 )$$

Similarly, the edge aggregation function AggEdgeₖ may also be generated by computing a single vector representation of the edges in the neighborhood of v. In embodiments, max pooling is used. This process is denoted by Equation (12) below.

$${AggEdge}_{k} = maxpool ( \{ σ ( {W}_{agge} {e}_{uv}^{k} + b ) , ∀ ( u , v ) ∈ ℰ : v ∈ N ( v ) \} ) \qquad ( 12 )$$

In some embodiments, the neural network also includes a classifier head, consisting of a linear layer, and a softmax layer, which are trained end to end as a binary classifier to perform either node classification or edge classification. FIG. 3C illustrates an example network 300C that may follow the neural network 300A configured to perform node classification. Network 300C includes a classifier head configured to receive the final node embedding 332 determined by the neural network 300A. The final node embedding 332 is passed through a linear layer 350C and a softmax layer 360C to output a classification score 370C.

FIG. 3D illustrates an example network 300D that may follow the neural network 300A configured to perform edge classification. Network 300D includes a classifier head configured to receive the final edge embedding 334 determined by the neural network 300A. The final edge embedding 334 is passed through a linear layer 350D and a softmax layer 360D to output a classification score 370D. In the example of lead scoring, historical leads with conversion labels may be used as target variables. A loss function used is cross entropy. Edge classification is performed by passing the edge embeddings (qᵤᵥ) through a linear layer with softmax layer at the top as shown in Equations (13)-(14) below.

$$\overline{{y}_{uv}} = softmax ( {q}_{uv}^{T} {W}_{classifier} ) \qquad ( 13 )$$

$$L = - {\sum }_{( uv ) ∈ ℰ} {y}_{uv} log ( \overline{{y}_{uv}} ) + ( 1 - {y}_{uv} ) log ( 1 - \overline{{y}_{uv}} ) \qquad ( 14 )$$

Similarly, node classification can also be performed by using the node embeddings and passing through linear with softmax layer at the top.

The lead scoring example, merchant recommendation model, and fraud detection model are merely example use cases to introduce and explain the problem The model described herein can be applied to any domain and use case where data can be represented as a graph where different nodes are connected to each other with different ways, and both node features and edge features contain useful information.

### Example Process for Determining Node-Embeddings and Edge Embeddings for Nodes or Edges in Graphs

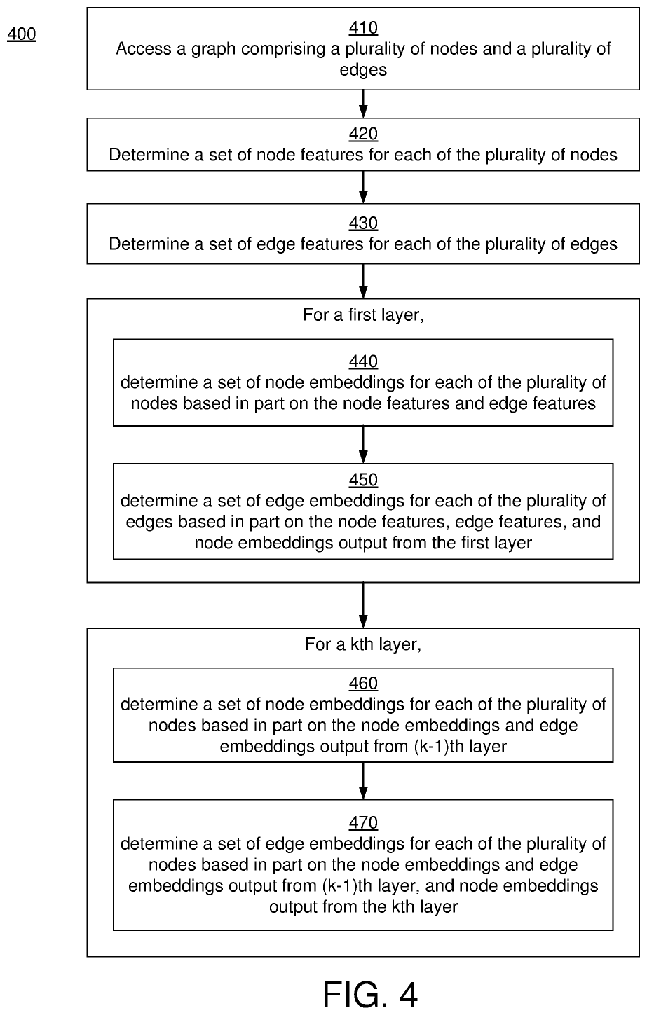

FIG. 4 is a flowchart of an example method 400 for determining node embeddings and edge embeddings for nodes or edges in graphs. In various embodiments, the method includes different or additional steps than those described in conjunction with FIG. 4. Further, in some embodiments, the steps of the method may be performed in different orders than the order described in conjunction with FIG. 4. The method described in conjunction with FIG. 4 may be carried out by system 200 in various embodiments, while in other embodiments, the steps of the method are performed by any computer system capable of accessing a pre-trained neural network.

The system 200 accesses 410 a graph comprising a plurality of nodes and a plurality of edges linking the plurality of nodes. For example, each node may represents an entity, and each edge linking two nodes represents interactions or relationship between the two nodes. The system 200 determines 420 a set of node features for each of the plurality of nodes based on information related to the node. The system 200 determines 430 a set of edge features for each of the plurality of edges based on information related to the edge.

For a first layer, the system 200 determines 440 a set of node embeddings for each of the plurality of nodes based in part on the node features and edge features. The machine learning system also determines 450 a set of edge embeddings for each of the plurality of edges based in part on the node features, edge features, and node embeddings output from the first layer.

For a kth layer (where k is a natural number, and k>1), the system 200 determines 460 a set of node embeddings for each of the plurality of nodes based in part on the node embeddings and edge embeddings output from the (k−1)th layer. The system 200 also determines 470 a set of edge embeddings for each of the plurality of nodes based in part on node embeddings and edge embeddings output from (k−1)th layer, and the node embeddings output from the kth layer.

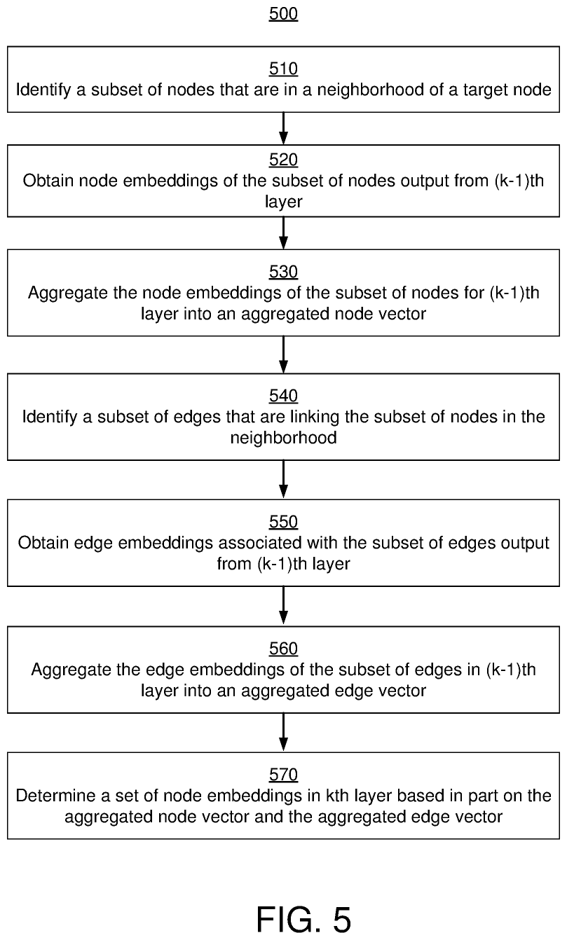

FIG. 5 is a flowchart of an example method 500 for determining a set of node embeddings for a target node in kth layer, which corresponds to step 460 of FIG. 4. In various embodiments, the method includes different or additional steps than those described in conjunction with FIG. 5. Further, in some embodiments, the steps of the method may be performed in different orders than the order described in conjunction with FIG. 5.

The system 200 identifies 510 a subset of nodes that are in a neighborhood of the target node. In some embodiments, a neighborhood function N(v) is applied to the target node to sample neighboring nodes of the target node v. The number of neighborhood nodes is decided by constants S₁, . . . , S_{K}, ∀K∈{1, . . . , K}.

The system 200 obtains 520 node embeddings of the subset of nodes output from (k−1)th layer. The system 200 aggregates 530 the node embeddings of the subset of nodes for (k−1)th layer into an aggregated node vector. For a node v, an aggregated node vector, denoted by h_{N(v)}^{k}, is generated. In some embodiments, this is performed by applying AggNodeₖ function to the vector representation of the neighboring nodes hᵤ^{k-1} at depth k−1. The neighboring nodes are provided by N(v). This process may be denoted by Equation (3).

The system 200 identifies 540 a subset of edges that are linking the subset of nodes in the neighborhood. The system 200 obtains 550 edge embeddings associated with the subset of edges output from (k−1)th layer. The system 200 aggregates 560 the edge embeddings of the subset of edges output from (k−1)th layer into an aggregated edge vector. For an edge (u, v), an aggregated edge vector, denoted by eᵤᵥ^{k-1}, is generated. In embodiments, this is performed by applying AggEdgeₖ function to the vector representation of the neighboring edges eᵤᵥ^{k-1} at depth k−1. This process may be denoted by Equation (4).

The system 200 determines 570 a set of node embeddings in kth layer based in part on the aggregated node vector and the aggregated edge vector. For a node v, an embedding, denoted by hᵥ^{k}, is determined. In embodiments, this is performed by concatenating the node's depth k−1 representation hᵥ^{k-1} with the aggregated neighbourhood node vector h_{N(v)}^{k}, and the aggregated neighbourhood edge vector h_{N(v)}^{k}. This process may be denoted by Equation (5).

In some embodiments, the node embeddings are normalized. The process of normalization may be denoted by Equation (7).

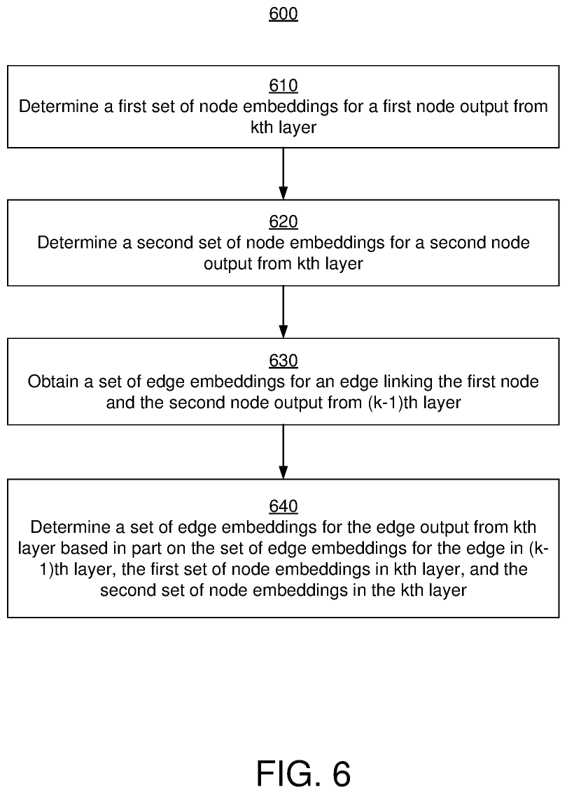

FIG. 6 is a flowchart of an example method 600 for determining a set of edge embeddings for a target edge (u, v) in kth layer, which corresponds to step 470 of FIG. 4. In various embodiments, the method includes different or additional steps than those described in conjunction with FIG. 6. Further, in some embodiments, the steps of the method may be performed in different orders than the order described in conjunction with FIG. 6.

The system 200 determines 610 a first set of node embeddings for a first node u output from kth layer, which corresponds to method 500 in FIG. 5. The system 200 determines 620 a second set of node embeddings for a second node v output from kth layer, which also corresponds to method 500 in FIG. 5.

The system 200 determines 630 a set of edge embeddings for an edge linking the first node u and the second node v output from (k−1)th layer. The system 200 determines 640 a set of edge embeddings for the edge in kth layer based in part on the first set of node embeddings for the first node u in kth layer, the second set of node embeddings for the second node v in kth layer, and the set of edge embeddings for the edge (u, v) in (k−1) the layer.

In embodiments, this is performed by concatenating the edge embeddings at depth k−1, with the update depth k node embeddings of nodes u and v. The concatenated vector is passed through a fully connected neural network layer with nonlinear activation σ and depth k weights W_{edge}^{k}. This process may be denoted by equation (6). In some embodiments, the edge embeddings are normalized. The process of normalization may be denoted by Equation (8).

### Computer Architecture

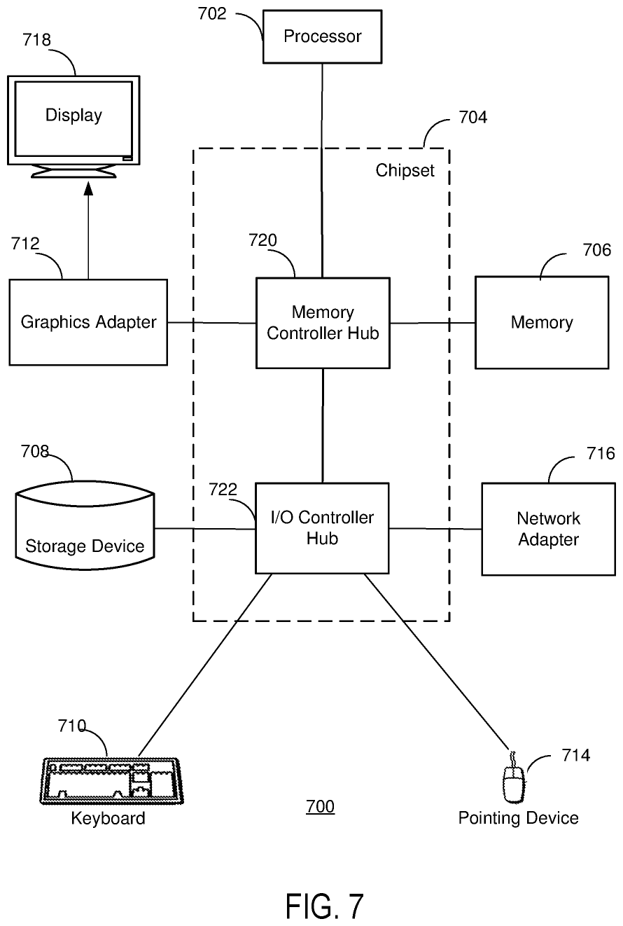

FIG. 7 is a block diagram illustrating the architecture of a typical computer system 700 for use in the system 200 of FIG. 2 according to one embodiment. Illustrated are at least one processor 702 coupled to a chipset 704. Also coupled to the chipset 704 are a memory 706, a storage device 708, a keyboard 710, a graphics adapter 712, a pointing device 714, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is a non-transitory computer-readable storage medium, such as a hard drive, compact disk read-only memory (CD-ROM), DVD, or a solid-state memory device. The memory 706 holds instructions and data used by the processor 702. The pointing device 714 may be a mouse, track ball, or other type of pointing device, and is used in combination with the keyboard 710 to input data into the computer system 700. The graphics adapter 712 displays images and other information on the display 718. The network adapter 716 couples the computer system 700 to a network.

As is known in the art, a computer system 700 can have different and/or other components than those shown in FIG. 7. In addition, the computer system 700 can lack certain illustrated components. For example, a computer system 700 acting as system 200 may lack a keyboard 710 and a pointing device 714. Moreover, the storage device 708 can be local and/or remote from the computer system 700 (such as embodied within a storage area network (SAN)).

The computer system 700 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 708, loaded into the memory 706, and executed by the processor 702.

The types of computer systems 700 used by the system of FIG. 2 can vary depending upon the embodiment and the processing power used by the entity. For example, a client device may be a mobile phone with limited processing power, a small display 718, and may lack a pointing device 714. The system 200 in contrast, may comprise multiple blade servers working together to provide the functionality described herein.

### ADDITIONAL CONSIDERATIONS

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real-time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes and may not have been selected to delineate or circumscribe the inventive subject matter. Accordingly, the disclosure of the embodiments is intended to be illustrative, but not limiting.

We claim:

1. A computer-implemented method, the method comprising:
accessing a neural network having K layers, where K is a natural number, K>1;
accessing a graph comprising a plurality of nodes and a plurality of edges linking the plurality of nodes;
determining a set of node features for each of the plurality of nodes based on information associated with the node;
determining a set of edge features for each of the plurality of edges based on information associated with the edge;
applying a first layer of the neural network to the node features and the edge features to output a first set of node embeddings and a first set of edge embeddings;
applying a kth layer of the neural network to (k−1)th set of node embeddings and (k−1)th set of edge embeddings to output a kth set of node embeddings and a kth set of edge embeddings, where k is a natural number, wherein the (k−1)th set of node embeddings and (k−1)th set of edge embeddings are output from (k−1)th layer of the neural network, k is a natural number, and K≥k>1.

2. The computer-implemented method of claim 1, wherein applying the kth layer in the plurality of layers of the neural network to output a k-th set of node embeddings for a target node comprises:
identifying a subset of nodes that are in a neighborhood of the target node;
obtaining node embeddings of the subset of nodes output from (k−1)th layer;
aggregating the node embeddings of the subset of nodes output from (k−1)th layer into an aggregated node vector;
identifying a subset of edges that are linking the subset of nodes in the neighborhood;
obtaining edge embeddings associated with the subset of edges in (k−1)th layer;
aggregating the edge embeddings of the subset of edges in (k−1)th layer into an aggregated edge vector; and
determining a set of node embeddings in kth layer based in part on the aggregated node vector and the aggregated edge vector.

3. The computer-implemented method of claim 2, wherein determining the set of node embeddings in kth layer based in part on the aggregated node vector and the aggregated edge vector comprises:
concatenating the aggregated node vector and the aggregated edge vector to generate a concatenated vector; and
passing the concatenated vector through kth layer of the neural network with an activation function to generate a set of node embeddings.

4. The computer-implemented method of claim 1, wherein determining a set of node embeddings for each of the plurality of nodes further comprises normalizing each set of node embeddings based on all sets of node embeddings in a same layer of the neural network.

5. The computer-implemented method of claim 1, wherein applying the kth layer in the plurality of layers of the neural network to output a set of edge embeddings for an edge (u, v) linking a node u and a node v comprises:
outputting a first set of node embeddings for the node u;
outputting a second set of node embeddings for the node v;
obtaining a set of edge embeddings for the edge (u, v) output from (k−1)th layer; and
outputting a set of edge embeddings for the edge (u, v) based in part on the set of edge embeddings for the edge output from (k−1)th layer, the first set of node embeddings, and the second set of node embeddings.

6. The computer-implemented method of claim 1, wherein determining a set of edge embeddings for each of the plurality of nodes further comprises normalizing each set of edge embeddings based on all sets of edge embeddings in a same layer of the neural network:

7. The computer-implemented method of claim 1, wherein the neural network includes a total of K layers, and the node embeddings and edge embeddings for Kth layer are final set of node embeddings and final set of edge embeddings.

8. The computer-implemented method of claim 7, wherein the neural network further includes a classifier head, a linear layer, and a softmax layer, and the classifier head is configured to:
receive the final set of node embeddings as inputs; and
pass the final set of node embeddings through the linear layer and the softmax layer to output a classification score.

9. The computer-implemented method of claim 7, wherein the neural network further includes a classifier head, a linear layer, and a softmax layer, and the classifier head is configured to:
receive the final set of edge node embeddings as inputs; and
pass the final set of edge embeddings through the linear layer and the softmax layer to output a classification score.

10. A non-transitory computer-readable medium, stored thereon computer-executable instructions, that when executed by a processor of a computer system, cause the computer system to:
access a neural network having K layers, where K is a natural number, K>1;
access a graph comprising a plurality of nodes and a plurality of edges linking the plurality of nodes;
determine a set of node features for each of the plurality of nodes based on information associated with the node;
determine a set of edge features for each of the plurality of edges based on information associated with the edge;
apply a first layer of the neural network to the node features and the edge features to output a first set of node embeddings and a first set of edge embeddings;
apply a kth layer of the neural network to (k−1)th set of node embeddings and (k−1)th set of edge embeddings to output a kth set of node embeddings and a kth set of edge embeddings, where k is a natural number, wherein the (k−1)th set of node embeddings and (k−1)th set of edge embeddings are output from (k−1)th layer of the neural network, k is a natural number, and K≥k>1.

11. The non-transitory computer-readable medium of claim 10, wherein applying the kth layer in the plurality of layers of the neural network to output a kth set of node embeddings for a target node comprises:
identifying a subset of nodes that are in a neighborhood of the target node;
obtaining node features of the subset of nodes output from (k−1)th layer;
aggregating the node features of the subset of nodes output from (k−1)th layer into an aggregated node vector;
identifying a subset of edges that are linking the subset of nodes in the neighborhood;
obtaining edge features associated with the subset of edges in (k−1)th layer;
aggregating the edge features of the subset of edges in (k−1)th layer into an aggregated edge vector; and
determining a set of node embeddings in kth layer based in part on the aggregated node vector and the aggregated edge vector.

12. The non-transitory computer-readable medium of claim 11, wherein determining the set of node embeddings in kth layer based in part on the aggregated node vector and the aggregated edge vector comprises:
concatenating the aggregated node vector and the aggregated edge vector to generate a concatenated vector; and
passing the concatenated vector through kth layer of the neural network with an activation function to generate a set of node embeddings.

13. The non-transitory computer-readable medium of claim 10, wherein determining a set of node embeddings for each of the plurality of nodes further comprises normalizing each set of node embeddings based on all sets of node embeddings in a same layer of the neural network.

14. The non-transitory computer-readable medium of claim 10, wherein applying the kth layer in the plurality of layers of the neural network to output a set of edge embeddings for an edge (u, v) linking a node u and a node v comprises:
outputting a first set of node embeddings for the node u;
outputting a second set of node embeddings for the node v;
obtaining a set of edge embeddings for the edge (u, v) output from (k−1)th layer; and
outputting a set of edge embeddings for the edge (u, v) based in part on the set of edge embeddings for the edge output from (k−1)th layer, the first set of node embeddings, and the second set of node embeddings.

15. The non-transitory computer-readable medium of claim 10, wherein determining a set of edge embeddings for each of the plurality of nodes further comprises normalizing each set of edge embeddings based on all sets of edge embeddings in a same layer of the neural network:

16. The non-transitory computer-readable medium of claim 10, wherein the neural network includes a total of K layers, and the node embeddings and edge embeddings for Kth layer are final set of node embeddings and final set of edge embeddings.

17. The non-transitory computer-readable medium of claim 16, wherein the neural network further includes a classifier head, a linear layer, and a softmax layer, and the classifier head is configured to:
receive the final set of node embeddings as inputs; and
pass the final set of node embeddings through the linear layer and the softmax layer to output a classification score.

18. The non-transitory computer-readable medium of claim 16, wherein the neural network further includes a classifier head, a linear layer, and a softmax layer, and the classifier head is configured to:
receive the final set of edge node embeddings as inputs; and
pass the final set of edge embeddings through the linear layer and the softmax layer to output a classification score.

19. A computer system comprising:
a processor; and
a non-transitory computer-readable storage medium, stored thereon computer-executable instructions, that when executed by the processor, cause the processor to perform:
access a neural network having K layers, where K is a natural number, K>1;
access a graph comprising a plurality of nodes and a plurality of edges linking the plurality of nodes;
determine a set of node features for each of the plurality of nodes based on information associated with the node;
determine a set of edge features for each of the plurality of edges based on information associated with the edge;
apply a first layer of the neural network to the node features and the edge features to output a first set of node embeddings and a first set of edge embeddings;
apply a kth layer of the neural network to (k−1)th set of node embeddings and (k−1)th set of edge embeddings to output a kth set of node embeddings and a kth set of edge embeddings, where k is a natural number, wherein the (k−1)th set of node embeddings and (k−1)th set of edge embeddings are output from (k−1)th layer of the neural network, k is a natural number, and K≥k>1.

20. The computer system of claim 19, wherein applying the kth layer in the plurality of layers of the neural network to output a kth set of node embeddings for a target node comprises:
identifying a subset of nodes that are in a neighborhood of the target node;
obtaining node features of the subset of nodes output from (k−1)th layer;
aggregating the node features of the subset of nodes output from (k−1)th layer into an aggregated node vector;
identifying a subset of edges that are linking the subset of nodes in the neighborhood;
obtaining edge features associated with the subset of edges in (k−1)th layer;
aggregating the edge features of the subset of edges in (k−1)th layer into an aggregated edge vector; and
determining a set of node embeddings in kth layer based in part on the aggregated node vector and the aggregated edge vector.
